(19) United States
(12) Patent Application Publication
(10) Pub. No.: US 2005/0133069 A1
(43) Pub. Date: Jun. 23, 2005

(54) Gumming medium

(75) Inventors: Thomas Hartmann, Neusass-Westheim (DE); Herbert Langer, Oberndorf (DE); Michael Wagner, Augsburg (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: MAN Roland Druckmaschinen AG, Offenbach am Main (DE)

(21) Appl. No.: 11/009,724

(22) Filed: Dec. 10, 2004

(30) Foreign Application Priority Data
Dec. 13, 2003 (DE) 103 58 461.7

(51) Int. Cl. B08B 3/14

(52) U.S. Cl. 134/42

(57) ABSTRACT

The invention provides a gumming medium for the treatment of printing plates comprising a buffer solution, a water-soluble polymer, a surfactant, and, optionally, a polyhydroxy compound. The invention further provides a printing process utilizing the medium, and a process utilizing the medium as a pretreatment composition for the temporary protection of fresh printing plates from soiling and from the influence of external factors.

### FIELD OF THE INVENTION

The present invention relates to a gumming medium, referred to below simply as a “medium,” for the pretreatment of printing plates, a printing process utilizing the medium, and a process utilizing the medium as a pretreatment composition for the temporary protection of fresh printing plates from soiling and from the influence of external factors.

### BACKGROUND OF THE INVENTION

A printing process in which a printing plate cylinder is provided with adhesive at points and imagewise is known. This printing plate cylinder is then coated with printing inks for an offset process, and the printing ink of the ink-carrying parts is picked up by a rubber roller and transferred to the substrate on which the image is to be printed. For rapid changing of the print motifs, in particular for short print runs, it is desirable to carry out the process within the apparatus firstly as far as possible with computer control and secondly without changing moveable parts. The printing apparatus presented in EP-B-0 698 488 fulfills these requirements.

The printing plate cylinder used in the abovementioned apparatus is coated at points and imagewise with a polymer which originates from a thermal transfer ribbon. For obtaining lithographic printing plates suitable for offset printing—this means distinct separation of the hydrophilic parts (those parts on the printing plate cylinder which are not coated with polymer) and hydrophobic parts (those parts on the printing plate cylinder which are coated with polymer and subsequently represent the ink-carrying parts in the printing process)—certain physical and chemical parameters of the printing plates must be achieved and maintained during the printing process. The printing process mentioned (DICO process) takes place in successive stages which are repeated cyclically per printing process. To date, the cycle sequence used for this process comprises the steps of de-imaging, imaging, fixing, conditioning and proof printing. For certain product segments in the graphic arts industry, printing jobs having substantially higher requirements (negative font, very fine screens also in the case of frequency modulation, difficult halftone transitions) can be produced without errors by this process. This process therefore results in a substantially broader available product range than in the conventional TT process.

While the aforementioned process is capable of producing quality images in a wide range of printing applications, the process is still susceptible to some of the problems that are common to other offset printing processes. For example, the printing plate cylinder can be susceptible to scumming, which is a buildup of ink that is bonded to non-image areas of the plate.

A need therefore exists for a composition for treating printing plates to prevent scumming and improve the overall performance of the printing process. A need also exists for a printing process utilizing such a composition to treat the printing plate. The present invention provides such a composition and method. These and other advantages of the present invention, as well as additional inventive features, will be apparent from the description of the invention provided herein.

### BRIEF SUMMARY OF THE INVENTION

The invention provides a gumming medium comprising (a) a buffer solution having a pH of from 2.0 to 5.5, (b) a water-soluble polymer in an amount of from 1 to 50 percent by weight, (c) a surfactant in an amount of from 0.001 to 10 percent by weight, and, optionally, (d) a polyhydroxy compound differing from (a), (b) or (c).

The invention further provides a printing process comprising the step of utilizing a gumming medium comprising (a) a buffer solution having a pH of from 2.0 to 5.5, (b) a water-soluble polymer in an amount of from 1 to 50 percent by weight, (c) a surfactant in an amount of from 0.001 to 10 percent by weight, and, optionally, (d) a polyhydroxy compound differing from (a), (b) or (c), for the pretreatment of a printing plate.

### DETAILED DESCRIPTION OF THE INVENTION

The present invention provides a medium, which may also be referred to as gumming medium, comprising (a) a buffer solution having a pH of from 2.0 to 5.5, (b) a water-soluble polymer in an amount of from 1 to 50 percent by weight, (c) a surfactant in an amount of from 0.001 to 10 percent by weight, and, optionally, (d) a polyhydroxy compound differing from (a), (b) or (c).

A phosphate buffer is preferably used as the buffer solution (component a), it being possible to use potassium or sodium phosphates—individually or as a mixture. The amount of phosphate buffer, i.e., the sum of the weight of the mixture of, for example, potassium dihydrogen phosphate and phosphoric acid, is preferably from 0.5 to 5% by weight of the total amount of the medium. The buffer mixture is not limited to Na and/or K hydrogen phosphate, and mixtures of basic and acidic Na and/or K phosphate are also conceivable. The naming of these buffer mixtures does not mean that similar results would also be achievable with other buffer mixtures, for example other phosphates.

The buffer solution has a pH of from 2.0 to 5.5, preferably from 3.5 to 4.5. The components of the buffer are preferably potassium dihydrogen phosphate (crystalline, superpure) and phosphoric acid (85%, reagent grade) and are obtained, for example, from Merck or now VWR International.

The water-soluble polymer (component b) preferably is selected from the group consisting of dextrins, polyvinyl alcohols, gum arabic, sodium carboxymethylcellulose, polyvinylpyrrolidones and inorganic polymers. Preferred quantity ranges for the water-soluble polymer are from 1 to 50% by weight, based on the weight of the total medium, in particular from 5 to 30% by weight, preferably from 10 to 20% by weight, based on the weight of the total medium.

Dextrins which can be used in the present invention are starch degradation products of the general formula (C₆H₁₀O₅)ₙ.xH₂O, which form on incomplete hydrolysis with dilute acids (acid dextrins) or by the action of heat. They consist of glucose chains. The enzymatic degradation with amylases gives so-called limiting dextrins, in which the 1,6-glycoside bonds of the amylopectin which are not accessible to attack by β-amylase are enriched while cyclodextrins form, for example, in the case of the action of Bacillus macerans on starch solution.

Dextrin forms a colorless or yellow, amorphous powder which is very soluble in water but almost completely insoluble in alcohol. Dextrins can be prepared from a very wide range of starch types, for example maize or potatoes. The molar masses of the dextrins are between 2,000 and 30,000. The dextrins form very tacky syrups with a little water, and it is for this reason that dextrins are also referred to as starch gum. One manufacturer of dextrins is, for example, National Starch and Chemistry (Holdings) Ltd.

The polyvinyl alcohols which can be used in the present invention are not accessible by direct polymerization processes, since the parent monomer vinyl alcohol required for this purpose does not exist. Polyvinyl alcohols are therefore prepared via polymer-analogous reactions by hydrolysis, but industrially in particular by alkaline catalyzed transesterification of polyvinyl acetates with alcohols (preferably methanol) in solution.

Commercial polyvinyl alcohols, which are offered as yellowish white powders or granules having degrees of polymerization in the range of about 500 to 2,500 (corresponding to molar masses of about 20,000-100,000 g/mol) have different degrees of hydrolysis of 98-99 or 87-89 mol %. They are therefore partly hydrolyzed polyvinyl acetates having a residual content of about 1-2 or 11-13 mol %, respectively, of acetyl groups. The polyvinyl alcohols are characterized by stating the degree of polymerization of the starting polymer, the degree of hydrolysis, the saponification number, or the solution viscosity.

Transformation temperatures of the polyvinyl alcohols are dependent on the content of acetyl groups, the distribution of the acetyl groups along the chain and the tacticity of the polymers. Completely hydrolyzed polyvinyl alcohols have a glass transition temperature of about 85° C. and a melting point of about 228° C. The corresponding values for partly hydrolyzed (87-89%) products are substantially lower at about 58° C. or 186° C. Polyvinyl alcohols, D=1.2-1.3 g/cm³, are, depending on the degree of hydrolysis, soluble in water and a few strongly polar organic solvents (formamide, dimethylformamide, dimethyl sulfoxide); they are not attacked by (chlorinated) hydrocarbons, esters, fats and oils. Polyvinyl alcohols are classified as toxicologically safe and are at least partly biodegradable.

The water solubility can be reduced by treatment with aldehydes (acetalation, production of polyvinyl acetals), by complexing with Ni or Cu salts or by treatment with dichromates, boric acid or borax. Films of polyvinyl alcohols are substantially impermeable to gases, such as oxygen, nitrogen, helium, hydrogen or carbon dioxide, but allow water vapor to pass through.

Polyvinyl alcohols have a wide range of uses, for example as protective colloid, emulsifier and binder and for protective skins and adhesives. Polyvinyl alcohol mixed with dichromates or diazonium compounds serves, inter alia, as a light-sensitive layer for the production of offset printing plates. As reactive polymers which can be chemically broadly varied (acetalated, esterified, etherified or crosslinked) via the secondary hydroxyl groups, polyvinyl alcohols serve as raw materials for the preparation of polyvinylacetals (e.g., polyvinylbutyrals). Manufacturers of polyvinyl alcohol and its derivatives are, for example, Celanese Chemicals, Ltd., Colltec GmbH & Co. KG, Rhodia PPMC, Wacker Polymer Systems, Hansa Chemie AG and Kuraray Ltd., Co.

The gum arabic which can be used in the present invention, also referred to as acacia gum, arabic gum, Sudan gum or Senegal gum, comprises colorless to brown, matte, brittle, odorless pieces having a glossy fracture or powders which dissolve in warm water to give a clear, viscous, tacky, insipid-tasting and weakly acidic liquid. Gum arabic is substantially insoluble in alcohol. Gum arabic consists mainly of the acidic alkaline earth metal and alkali metal salts of so-called arabic acid (polyarabic acid), which is understood as meaning a branched polysaccharide consisting of L-arabinose, D-galactose, L-rhamnose and D-glucuronic acid in the ratio 3:3:1:1.

Gum arabic is very widely used worldwide, for example as a thickener, as a binder, as a finishing component, for the preparation of galactose, as a commercial adhesive for gumming and in medical preparations. A supplier of gum arabic is, inter alia, Benecke, Hamburg, which offers gum arabic in various qualities, for example, as a grade satisfying the requirements of United States Pharmacopoeia USP23 and European Union Specification E-414.

The sodium carboxymethylcellulose or carboxymethylcellulose (abbreviation CMC or CMCNa) which can be used in the present invention is generally designated the sodium salt of the glycolic ether of cellulose (or often used but incorrect designation: cellulose glycolate). Carboxymethylcellulose is produced industrially by reacting alkali metal cellulose with monochloroacetic acid or the sodium salt thereof in the absence or presence of an organic solvent (e.g., isopropanol). The resulting carboxymethylcellulose, which contains sodium chloride and sodium glycolate and diglycolate as byproducts of the reaction as a result of the production, is used impure or in substantially salt-free form after washing with aqueous organic solvent. Commercial carboxymethylcellulose is a colorless powder or comprises granules and is offered with degrees of substitution of about 0.5-1.5 and a wide range of solution viscosities. Carboxymethylcellulose is insoluble in organic solvent but soluble in water, from which it is precipitated as a polyelectrolyte by addition of acids, salts or polyvalent metal ions (e.g., Cu²⁺, Al³⁺, Fe²⁺, or Fe³⁺). The acid form of carboxymethylcellulose (abbreviation HCMC) is insoluble in water, acids and organic solvents but soluble in aqueous alkali.

Owing to its broad property spectrum, carboxymethylcellulose has a very wide range of uses, for example in the detergent and cleaning agent industry, in the pharmaceutical and cosmetic industry, in the food industry, in the tobacco industry, in the chemical industry, in the paint industry, in the ceramic industry, in the paper industry, in the textile industry, in the building materials industry, in the petroleum industry, in mining, in other branches of industry as binders and in pyrotechnics. Manufacturers of CMC or Na-CMC include Clariant Functional Chemicals, Aqualon-Hercules GmbH, Wolff Cellulosics GmbH & Co. KG and Akzo Nobel Functional Chemicals B.V.

The polyvinylpyrrolidones which can be used in the present invention, i.e., poly(1-vinyl-2-pyrrolidinones), abbreviation PVP, are prepared by free radical polymerization of 1-vinylpyrrolidone by solution or suspension polymerization methods using free radical formers (e.g., peroxides or azo compounds) as initiators. Ionic polymerization of the monomer only yields products having low molar masses.

Commercial polyvinylpyrrolidones have molar masses in the range of about 2,500-750,000 g/mol, which are characterized by stating the K values and—depending on the K value—have glass transition temperatures of 130-175° C. They are offered as white, hygroscopic powders or as aqueous solutions.

Polyvinylpyrrolidones are readily soluble in water and a large number of organic solvents (alcohols, ketones, glacial acetic acid, chlorohydrocarbons, phenols, etc.). Under the action of strong acids, the lactam ring of the polyvinylpyrrolidones hydrolyzes to 4-aminobutyric acid units; in the presence of alkali at elevated temperatures, the polyvinylpyrrolidones crosslink to give insoluble products.

With dyes, iodine, polyphenols, tannins and toxins, polyvinylpyrrolidones form complexes. Polyvinylpyrrolidones are used in medicine, in cosmetics, in textile processing and generally as thickeners.

The inorganic polymers which can be used in the present invention include a group of polymers whose main chains contain no carbon atoms but are composed of aluminum and/or boron, phosphorus, oxygen, sulfur, silicon, nitrogen and tin atoms. Inorganic polymers such as poly(boron nitrides), polyphosphates, polyphosphazenes, poly(silanes), poly(siloxanes), poly(sulfazenes) and polysulfides can have very good heat resistance in combination with moderate elasticity. Among them, the polyphosphazenes are of particular interest.

Component (c) comprises surfactants. Fluorine surfactants are particularly preferred. Fluorine surfactants which may be used are nonionic and ionic fluorine surfactants. The effect of fluorine surfactants or surfactants which act similarly to fluorine surfactants is important for the present invention. Component (c) is used in an amount of from 0.001 to 10 percent by weight, preferably from 0.01 to 5 percent by weight, and particularly preferably from 0.1 to 2 percent by weight. However, it is necessary to take into account the fact that the choice of surfactants may depend on the HLB value of the respective surfactant, on the wettability and on other factors, so that it may be necessary to use more surfactant in the case of a surfactant having a relatively moderate surface tension-lowering effect, for example from 2 to 10 percent by weight, or from 2 to 8 percent by weight, or from 2 to 6 percent by weight. On the other hand, in the case of very effective surfactants, ranges from 0.001 to 1 percent by weight, preferably from 0.001 to 0.1 percent by weight, or from 0.001 to 0.05 percent by weight are conceivable.

“Fluorine surfactants” is a group designation for surfactants which carry a perfluoroalkyl radical as a hydrophobic group. Fluorine surfactants are distinguished from nonfluorinated surfactants by lower c.m.c. values (relates to micelles) and, even in extremely low concentrations, therefore result in a substantial reduction in the surface tension of water. They have high chemical and thermal stability so that they can also be used in aggressive media and at high temperatures. In addition to ionic or nonionic perfluorosurfactants, partly fluorinated surfactants may also be used.

The fluorine surfactants which can be used in the present invention are obtained by electrochemical fluorination of the corresponding sulfonyl or acyl halides (Simons process), by telomerization of tetrafluoroethylene with perfluoroalkyl iodides, or by oligomerization with subsequent functionalization.

Fluorine surfactants are used, for example, as emulsifiers in PTFE preparation, in metal processing for covering electroplating baths to prevent the escape of corrosive vapors, as wetting agents in the production of photographic films and papers, as leveling agents in self-shine emulsions, as fire extinguishing agents, in the textile industry for imparting hydrophobic and oleophobic properties, and for dirt-repellent treatment.

Manufacturers of fluorine surfactants are, for example, Bayer AG or 3M. A preferred product is Bayowet FT 248. The surfactant Bayowet FT 248 is obtained from Borcher GmbH and has a purity of 50% FT active substance in water.

The optionally present component (d), i.e., a polyhydroxy compound, is preferably selected from PEG, PEG/PPG, glycerol, diglycerol, hexitols, pentitols, inositols and saccharides. It is preferably present in an amount of from 0 to 2 percent by weight. Depending on the behavior of the polyhydroxy compound in the medium, amounts of from 0 to 1 percent by weight or from 0.1 to 1.5 percent by weight are also conceivable.

Polyethylene glycols which can be used in the present invention are produced industrially by base-catalyzed polyaddition of ethylene oxide (oxirane), in systems generally containing small amounts of water, with ethylene glycol as an initiator molecule. They have molar masses in the range of about 200-5,000,000 g/mol, corresponding to degrees of polymerization (n) of from about 5 to greater than 100,000. In the broader context, products having n=2-4 (di-, tri- and tetramethylene glycol) are also included among the polyethylene glycols; they can be prepared as molecularly uniform products, whereas the polyethylene glycols having higher molar masses are polymolecular, i.e., consist of groups of macromolecules having different molar masses.

Liquid products having molar masses of less than about 25,000 g/mol are referred to as actual polyethylene glycols, abbreviation PEG, and the higher molecular weight solid products (melting point about 65° C.) as polyethylene oxides, abbreviation PEOX. Polyethylene oxides have an extremely low concentration of reactive terminal hydroxyl groups and have only weak glycol properties. Branched polyadducts of ethylene glycol with polyhydric alcohols are also referred to as polyethylene glycols.

Polyethylene glycols are liquid or waxy to solid products which are very soluble in water up to about 100° C. and in many organic solvents. Aqueous solutions have striking rheological properties. Polyethylene glycols are very stable to hydrolysis. Their chemical reactivity is determined by the terminal hydroxyl groups, which can be easily esterified (to polyethylene glycol esters), etherified (to polyalkylene glycol ethers), or reacted with isocyanates to give urethanes.

Polyethylene glycols are used, for example, as solubilizers, binders, consistency agents, emulsifiers, dispersants, protective colloids, plasticizers or release agents for very different fields of use. They are also used in the field of printing. In principle, all of the polyethylene glycols described above can be used in the present invention.

In the present invention, physical mixtures of polyethylene glycols and polypropylene glycols and copolymers of ethylene oxide and propylene oxide can also be used. Polypropylene glycol has a molecular weight of 250-4,000. The lower molecular weight members are miscible with water, whereas the higher molecular weight polypropylene glycols are scarcely soluble in water. The polypropylene glycols form as a result of polyaddition of propylene oxide with water or 1,2-propanediol, i.e. are glycol ethers, in the wider sense polyethers.

Glycerol (C₃H₈O₃, molecular weight 92.09) used in the present invention is a colorless, clear, odorless, sweet-tasting hygroscopic liquid of low mobility. Glycerol is miscible with water and alcohol in any ratio but sparingly soluble in ether and insoluble in benzine, benzene, petroleum ether, chloroform and fatty oils. Glycerol is used in many industrial areas, also in the area of printing. It is produced synthetically or by fat cleavage.

Diglycerol is the condensate of two molecules of glycerol. It is an extremely viscous and hydrophilic substance.

Hexitols, pentitols and inositols are sugar alcohols or pseudosugar alcohols. They occur naturally or can be prepared from the respective reducing sugars by hydrogenation. Important members of the hexitols are, for example, sorbitol, mannitol and dulcitol, and members of the pentitols are, for example, adonitol, arabitol and xylitol. Inositols are natural substances and occur in various isomeric forms, e.g., myo-inositol. In this invention, saccharides are to be understood as meaning the monomeric, dimeric and oligomeric reducing sugars, for example, glucose, galactose, fructose, maltose, maltotriose, lactose or sucrose. These substances can be obtained from Merck or VWR or from Aldrich. Major suppliers of, for example, sorbitol are, for example, Roquette Fr. or Cerestar.

In addition to the abovementioned components (a) to (c) and optionally (d), the medium according to the invention may also contain substances which act as preservatives. Suitable substances include biocides, such as fungicides and microbicides. A preferred biocide is, for example, Acticide mbs. These substances are chosen so that they do not adversely affect the function of the medium. As standard, Acticide mbs from Thor in Speyer is preferably used as a biocide (effective concentration 0.3%). In addition, however, the use of other biocides from Thor (e.g., Acticide F(N)) and products from other suppliers would also be conceivable.

Furthermore, dyes may be added for visualization of the coating. All dyes stable in the weakly acidic region (pH 2-6), such as, for example, quinoline yellow, should be capable of being used as the dye. By using a fluorescent dye, determination of the layer thickness on the sleeve is possible at the same time, which permits easy diagnosis of the layer. Fluorescent dyes which may be used are, for example, fluorescein, acridine orange, tetracyclines, porphyrins, rhodanine, or mixtures thereof. The following substances are also suitable: derivatives of 4,4′-diamino-2,2′-stilbenedisulfonic acid (flavonic acid), 4,4′-distyrylbiphenylene, methylumbelliferone, coumarin, dihydroquinolinone, 1,3-diarylpyrazoline, naphthalimide, benzoazole, benzisoxazole and benzimidazole systems linked via CH═CH bonds, and pyrene derivatives substituted by heterocycles.

The abovementioned components (a) to (c) and optionally (d) can be mixed in the usual manner. In general, the sequence is not important, so that mixing batches of certain combinations can also be prepared separately before the preparation of the final medium and can be stored until the final step. However, the following process has proved advantageous.

For the preparation, a phosphate buffer is first prepared (by dissolving potassium dihydrogen phosphate and phosphoric acid). The biocide (Acticide mbs) and the fluorine surfactant (Bayowet FT248) are dissolved in the phosphate buffer, and then gum arabic (type 4685H) is added. For complete dissolution of the gum arabic, the mixture is stirred for about one hour at room temperature using a magnetic stirrer.

Advantageous gumming of a printing plate for the printing process described above is achieved by means of the medium according to the invention. A substantial aspect in connection with the use of the medium according to the invention is the modification of the DICO printing process described above. The cycle sequence typically utilized in the DICO process is: de-imaging, imaging, fixing, conditioning, printing, and, subsequently, the start of a new cycle with de-imaging.

With the medium according to the invention, the sequence is now: de-imaging, imaging, treatment with the medium according to the invention, fixing, printing, and then the start of a new cycle with de-imaging. This change in the sequence of the cycle is important since the treatment of the fixed printing plate with the medium according to the invention no longer has any effect, i.e., the gumming step must take place before the fixing.

It should be noted here that, in a preferred embodiment of the process, after imaging, the sleeve is subjected to a thermal treatment either immediately (in the case of conditioning) or after application of the medium according to the invention. During this procedure, the sleeve is heated by means of inductive heating over a certain period (temperature profile) to a defined temperature (usually about 145° C.) in order to ensure relaxation and hence better adhesion of the polymer, transferred by thermal transfer, to the metal surface. The action of heat on the polymer is therefore from below through the heated sleeve.

The application of the medium according to the invention to the imaged printing cylinder is possible by means of various apparatuses. The following are examples:
(a) Application via the RBW (rubber blanket washing unit) to the RB (rubber blanket) and subsequently from the RB to the printing cylinder. First, a homogeneous wetting of the rubber blanket by means of the RBW is achieved. After the RBW is switched off, the RB is brought into contact with the printing cylinder for a defined period (1-10 sec) at high speed (150-250 rpm). Finally, the spray head of the RBW is cleaned with water. The fluorine surfactant or a surfactant having a similar action, e.g., a silicone surfactant, is indispensable here for producing a homogeneous layer on the RB, since complete wetting is made more difficult by the change from a lipophilic agent (RB detergent) to a hydrophilic agent (medium according to the invention).
(b) Application via a rubber roller which is wetted with a doctor blade, a brush, by spraying or with a cloth.
(c) Application via other apparatuses (e.g., a spray apparatus).

It should be noted that the properties of the medium according to the invention and the design of the application apparatus are interrelated.

The properties of the medium according to the invention are explained below, in particular with regard to their printing function: the medium according to the invention providing optimum film formation/spreading. It is assumed that this is achieved, inter alia, by the addition of a surfactant, in particular of a fluorine surfactant. Thus, a homogeneous film can be produced on the RB (in the application variant, via the rubber blanket), rubber roller or brush and sleeve. The quality of the film produced (free of bubble or film formation defects, uniformity of the layer thickness) can be checked, for example, by absorption or gloss measurements. In connection with the object relating to optimum spreading, it was found that certain surfactant combinations have a synergistic effect. Thus, the combination of an anionic surfactant (e.g., Triton X200) with a fluorine surfactant (e.g., Bayowet FT248) has a substantial synergistic effect if the action of the surfactant mixture is determined with the aid of the contact angle measuring method under the experimental conditions relevant to the invention. Effective mixtures are ratios of from 1:10 to 10:1, preferably from 1:2 to 2:1.

Good wetting of the printing plate surface by the medium is required. Contact angle measurements with media according to the invention have shown that they give values in the range of 50°-30° (0 s) to 40-20° (30 s) over a monitoring period of 30 s. Preferred ranges are 45°-35° (0 s) and 35°-25° (30 s), in particular about 40° (0 s) and 30° (30 s). The contact angle measurements are carried out on a KRÜSS Universal Surface Tester GH100/DSA II. Measurements were carried out at room temperature. The drop volume is adapted individually to the respective sample and is 1.9±0.9 μl in the present measurements. The measurement was carried out as follows. A drop of the respective surfactant solution was placed on the substrate surface and then the resulting contact angle was measured over a certain period by means of video recording. The substrate used was expediently the material of the printing plate to be used. This consists of a stainless steel having the designation “Hastelloy” which is obtained from Allegheny Rodney Metals in D 45538 Sprockhoevel. The material is a Ni-rich stainless steel 2.4819 having the surface properties customary for printing plates.

In this context, conventional offset printing plates which may be treated with the medium according to the invention may include the following:

| Manufacturer | Product |
|---|---|
| Agfa (positive plates) | Meridian P 5 S |
| Agfa (positive plates) | Meridian P 20 S |
| | Meridian P 51 |
| | Meridian P 71 |
| | P 450 |
| Eggen | SP 10 |
| | SP 11 |
| Fujifilm | VPL-E |
| | VPS-E |
| | VPU |
| | VPC-E |
| Kara | Detra |
| | Fotra |
| KPG | Capricorn Excel |
| | Virage |
| | LibraBlue |
| Lastra | Hydra |
| | Oro |
| | Futura 101 |
| | Sonic |
| Agfa (negative plates) | Zenith 550 |
| | Zenith N 61 |
| Eggen | SN 6 |
| Fujifilm | FND-E |
| | FNC-B |
| | VNSW-E |
| | VNN-E |
| | UVN-E |
| Kara | Iris |
| KPG | Winner |
| Lastra | Orion |
| | Nitiodev |
| Eggen (reverse and | SP 8 |
| projection plates | |
| Kara | Spektra |
| KPG | LibraBlue |
| KPG | Virage |
| | Vitesse |

The contact angle measurements have shown that the contact angles measured as described above are relatively on average 15°, preferably 10°, in particular 15° and even 20° lower compared with commercial gumming compositions (e.g., Agfa RC 795), i.e., the compositions according to the invention exhibit much better spreading than conventional compositions, in spite of contamination with additives. A reduction of a further 10-15° is possible by using a synergistic mixture, as, for example, described above.

The medium according to the invention has an acidic pH, namely pH 2.0 to 5.5 or preferably pH 3.5-4.5. Through this measure, an important requirement is fulfilled, namely that the imaging must not be damaged by the medium (gumming) according to the invention. Owing to the instability of the imaging in the basic range, it is therefore necessary to work in the acidic range, as proposed according to the invention. Owing to its properties, the medium according to the invention permits subsequent conditioning. This is relevant, for example, after defective individual imaging, a machine stop, etc. and prevents a completely new reequipping cycle, resulting in time and cost savings. In addition, an imaged printing plate is protected by the medium according to the invention without loss of the printing properties, with the result that storage of the sleeve for more than 12 hours is possible. It has been found that, by using the medium according to the invention, optimum idling behavior is also ensured even after 30 min or more without subsequent treatment.

The medium according to the invention is chemically resistant to conventional fountain solutions and rubber blanket detergents. Even “hot gumming” is possible since the medium is prepared at elevated temperatures and is thermally stable up to about 150° C. The stability can moreover be demonstrated by the water solubility of the medium after fixing in the printing press, which becomes clear through the idling behavior under standard conditions.

Through the choice of the ingredients and the processing/use thereof, it is possible to develop a product which has as low a viscosity as possible and is as phase-stable as possible. This is of particular importance because liquid circulations of printing presses encounter different climatic conditions depending on location and, depending on the design, cross-sectional restrictions and flow sinks frequently occur in the liquid circulations. Additional measures to prevent sedimentation of solid particles and/or emulsions having unstable phases, such as stirrers and the like, should be avoided. In addition, the medium can be applied without problems by means of nozzles, spray heads, capillaries, cannulae, etc. (cf. mist formation). The phase stability can be ensured by means of measurements using a gravitational centrifuge. The medium according to the invention is a low-viscosity liquid (determined by means of rheological measurements), with the result that the application via spray nozzles is facilitated. Neither blockage of the spray nozzles nor formation of residual drops on the nozzle occurs. Any clogging on excessively long standing can easily be prevented by flushing with water at the end of the gumming process. Owing to its special composition, the medium is thermally stable up to about 150° C. This is important for the subsequent fixing process, since otherwise the formation of the protective film would be disturbed. An important point for the functioning of the process is the complete removal of the medium according to the invention by the fountain solution prior to proof printing.

That the difficulties in the treatment of the imaged printing cylinder with a gumming solution consist mainly in ensuring homogeneous wetting of the printing sleeve should be emphasized. This is achieved by means of a surfactant, in particular of a fluorine surfactant, by the reduction in the surface tension to about 20 mN/m. Owing to the optimum wetting properties (especially for image and nonimage parts) of the medium according to the invention, there is a high degree of independence from the materials used:
During application by means of brushes, a very wide range of brush types is conceivable. The brush can be wetted without problems with the medium used, and the cleaning can be effected automatically and easily without residues by washing with water.
With the use of rubber blankets or rubber rollers, for example, materials such as nitrile rubber, EPDM, silicone rubber can be used.
The Shore A hardness of the top layer can be chosen over a wide range (25-80 Shore).
When the medium is used, the roughness of the rubber blankets (Rz) can be varied over the entire range between 2 and 12 μm available in practice.

By using porous rubber blankets or rubber rollers, both a storage effect, which facilitates the wetting process, and a suction effect can be achieved in the gumming process, which is helpful when removing imaging artifacts. Here too, cleaning is easily possible by washing with water.

The complete removal of the medium according to the invention manifests itself in proof printing by delayed ink acceptance in the image parts at a high concentration in the medium according to the invention, which, however, disappears rapidly in the production run.

The effect of the medium according to the invention can be assessed by means of the microscopic investigation of the printing sleeve before and after application of the medium according to the invention (reduction of the imaging artifacts) and by means of the print quality of the subsequent proof. The microscopic investigation relates to the reduction of the imaging artifacts by the medium according to the invention. By means of microscopic investigations before and after application of the medium according to the invention, a substantial reduction of the artifacts can be documented. Micrographs were prepared for this purpose. The quality improvement is also visible in the subsequent proof.

A substantial advantage of the medium according to the invention is the universal applicability in relation to all apparatuses. The wetting of the rubber blanket could be optimized with the medium according to the invention, regardless of the type (for example different manufacturers, roughness) and history of the rubber blanket (contamination with paper dust, ink, RB detergent).

### EXAMPLE

The following example further illustrates the invention but, of course, should not be construed as in any way limiting its scope. This example demonstrates the preparation of a gumming medium according to the invention and the use of the gumming medium in a printing process.

In the preparation of the medium according to the invention, the phosphate buffer is first prepared by dissolving potassium dihydrogen phosphate and phosphoric acid.

The biocide (Acticide mbs) and the fluorine surfactant (Bayowet FT248) are dissolved in the phosphate buffer, and then gum arabic (type 4685H) is added. For complete dissolution of the gum arabic, the mixture is stirred for about one hour at room temperature using a magnetic stirrer.

The amounts of the individual components (percent by weight) are shown in the table below:

| Raw material | 100 kg | | % |
|---|---|---|---|
| H₂O (demineralized) | 82.5 | kg | 82.50 |
| KH₂PO₄ | 1.65 | kg | 1.65 |
| H₃PO₄ | 56 | g | 0.056 |
| Acticide mbs* | 0.3 | kg | 0.30 |
| Bayowet FT 248* | 0.5 | kg | 0.50 |
| Gum arabic type 4685/H* | 15 | kg | 15.00 |
| Total | 100.006 | kg | 100% |

Biocide: Acticide mbs from Thor Chemie GmbH,
gum arabic type 4685/H from Willy Benecke GmbH,
surfactant: Bayowet FT248 from Borchers GmbH.

The medium prepared in this manner was tested according to the printing process mentioned in the description (i.e., the DICO process). In contrast to the customary sequence, the cycle of the individual steps of the process was changed to the following cycle: de-imaging, imaging, gumming with the medium according to the invention, fixing, and proof printing. On carrying out the tests, it was found that this sequence is essential for the use of the medium according to the invention.

If the original cycle sequence (de-imaging, imaging, fixing, gumming with medium according to the invention instead of the conditioning customary to date, and proof printing) is used, the quality improvement in the printed image cannot be achieved. This statement could once again be confirmed with a proof: pronounced scumming is observable, and the proof does not run freely.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A gumming medium for the treatment of printing plates for use in printing applications comprising:
(a) a buffer solution having a pH of from 2.0 to 5.5,
(b) a water-soluble polymer in an amount of from 1 to 50 percent by weight, and
(c) a surfactant in an amount of from 0.001 to 10 percent by weight.

2. The gumming medium of claim 1, wherein the medium further comprises a polyhydroxy compound differing from said buffer solution, said water-soluble polymer, and said surfactant.

3. The gumming medium of claim 1, wherein the buffer solution is a phosphate buffer.

4. The gumming medium of claim 3, wherein the phosphate buffer comprises about 0.5 to about 5% by weight of the total amount of the medium.

5. The gumming medium of claim 4, wherein the phosphate buffer is selected from the group consisting of potassium phosphate, sodium phosphate, and combinations thereof.

6. The gumming medium of claim 1, wherein the water-soluble polymer is selected from the group consisting of dextrins, polyvinyl alcohols, gum arabic, sodium carboxymethylcellulose, polyvinylpyrrolidones, and inorganic polymers.

7. The gumming medium of claim 1, wherein the surfactant is selected from the group consisting of ionic and nonionic fluorine surfactants.

8. The gumming medium of claim 2, wherein the polyhydroxy compound comprises up to about 2 percent by weight of the total amount of the medium.

9. The gumming medium of claim 2, wherein the polyhydroxy compound is selected from the group consisting of PEG, PEG/PPG, glycerol, diglycerol, hexitols, pentitols, inositols, and saccharides.

10. The gumming medium of claim 1, wherein the medium further comprises a dye or a biocide.

11. The gumming medium of claim 1, wherein the medium exhibits a contact angle of from 50°-30° (0 s) to 40-20° (30 s) over a monitoring period of 30 s, as measured using a KRÜSS Universal Surface Tester GH100/DSA II.

12. A printing process comprising the steps of providing a gumming medium comprising (a) a buffer solution having a pH of from 2.0 to 5.5, (b) a water-soluble polymer in an amount of from 1 to 50 percent by weight, and (c) a surfactant in an amount of from 0.001 to 10 percent by weight, pretreating a printing plate with the gumming medium, and printing with the printing plate.

13. The process of claim 12, wherein the gumming medium further comprises a polyhydroxy compound differing from said buffer solution, said water-soluble polymer, and said surfactant.

14. The process of claim 12 including the steps of de-imaging a printing plate to remove any images or residual ink from the surface of the printing plate, imaging the printing plate to apply an image to the surface of the printing plate, treating the printing plate with the gumming medium after said de-imaging and imaging, fixing the image on the printing plate, and printing the image on a suitable substrate.

15. The process of claim 12, including cleaning the printing plate to provide a clean surface, and treating said clean surface with said gumming medium to temporarily protect the printing plate from soiling and the influence of external factors.

16. The process of claim 12, wherein the process further comprises the step of de-imaging the printing plate to remove the image and any residual ink from the surface of the printing plate after the printing step.
